(19) United States
(12) Patent Application Publication
(10) Pub. No.: US 2023/0236791 A1
(43) Pub. Date: Jul. 27, 2023

(54) MEDIA CONTENT SEQUENCING

(71) Applicant: Spotify AB, Stockholm (SE)

(72) Inventors: Rishabh MEHROTRA, London (GB); Aaron Wen Hao Ng, London (GB)

(73) Assignee: Spotify AB, Stockholm (SE)

(21) Appl. No.: 17/581,790

(22) Filed: Jan. 21, 2022

(51) Int. Cl. G06F 3/16; G10H 1/00

(52) U.S. Cl. CPC G06F 3/165; G10H 1/0008; G10H 2210/076; G10H 2210/066

(57) ABSTRACT

A system and method for media content sequencing. Prior tracks for a listening session are segmented into groups based on attribute scores for an audial attribute. A preferred group is then selected, which can be based on user feedback regarding the prior tracks in the listening session. Candidate tracks, such as from a candidate track pool for future playback in the listening session, are also segmented into the groups of the prior tracks. The candidate tracks can then be ranked based on their associated group and the preferred group.

### BACKGROUND

Many people enjoy consuming media content over a period of time. When listening to a sequence of media content, the next track for playback may be selected. The next track may be selected based on a variety of factors, including maintaining listener happiness. One way to maintain listener happiness is to sequence media content in an order to smooth transitions. Accordingly, sequencing media content to smooth transitions in a sequence may increase or maintain listener happiness.

### SUMMARY

In general terms, this disclosure is directed to media content sequencing. Prior tracks for a listening session are segmented into groups based on attribute scores for an audial attribute. A preferred group is then selected, which can be based on user feedback regarding the prior tracks in the listening session. Candidate tracks, such as from a candidate track pool for future playback in the listening session, are also segmented into the groups of the prior tracks. The candidate tracks can then be ranked based on their associated group and the preferred group.

Various aspects are described in this disclosure, which include, but are not limited to, the following aspects.

One aspect is a method of ranking a set of candidate tracks for a listening session, the listening session including a set of prior tracks previously played and a set of candidate tracks to be selected from for future play in the listening session, the method comprising: identifying a set of prior attribute scores associated with the set of prior tracks, wherein the set of prior attribute scores includes, for each track in the set of prior tracks, an attribute score of an audial attribute; segmenting the set of prior attribute scores into a plurality of attribute score groups for the audial attribute for the listening session; selecting a preferred group of the plurality of attribute score groups; and ranking the set of candidate tracks based at least in part on the preferred group for the audial attribute.

Another aspect is a method of ranking a set of candidate tracks for a listening session, the listening session including a set of prior tracks previously played and a set of candidate tracks to be selected from for future play in the listening session, the method comprising: identifying a set of prior attribute scores associated with the set of prior tracks, wherein the set of prior attribute scores includes, for each track in the set of prior tracks, an attribute score of an audial attribute; segmenting the set of prior attribute scores into a plurality of first attribute score groups for the audial attribute for the listening session; selecting a first preferred group of the plurality of first attribute score groups; ranking the set of candidate tracks based at least in part on the first preferred group for the audial attribute; playing a next track, based on the ranking; updating the set of prior attribute scores for the set of prior tracks to include an attribute score of the played next track; re-segmenting the set of prior attribute scores, including the attribute score of the played next track, into a plurality of second attribute score groups for the audial attribute for the listening session; selecting a second preferred group of the plurality of second attribute score groups; re-ranking the set of candidate tracks based at least in part on the second preferred group for the audial attribute.

A further aspect is a non-transitory computer-readable medium comprising: at least one processing device; and one or more sequences of instructions that, when executed by the at least one processing device, cause the at least one processing device to: identify a set of prior attribute scores associated with a set of prior tracks previously played, wherein the set of prior attribute scores includes, for each track in the set of prior tracks, an attribute score of an audial attribute; segment the set of prior attribute scores into a plurality of attribute score groups for the audial attribute for a listening session; select a preferred group of the plurality of attribute score groups; and rank a set of candidate tracks to be selected from for future play in the listening session, based at least in part on the preferred group for the audial attribute.

### BRIEF DESCRIPTION OF THE DRAWINGS

The following drawing figures, which form a part of this application, are illustrative of aspects of systems and methods described below and are not meant to limit the scope of the disclosure in any manner, which scope shall be based on the claims.

FIG. 1 illustrates an example system for sequencing tracks based on audial attribute score groups of prior tracks in a listening session.

FIG. 2 illustrates an example system for sequencing tracks based on audial attribute score groups of prior tracks in a listening session.

FIG. 3 illustrates an example method for sequencing tracks based on audial attribute score groups of prior tracks in a listening session.

FIG. 4A illustrates a conceptual diagram of example listening sessions of a user.

FIG. 4B illustrates a conceptual diagram of another example listening sessions of a user.

FIG. 4C illustrates a conceptual diagram of another example listening sessions of a user.

FIG. 4D illustrates a conceptual diagram of another example listening sessions of a user.

FIG. 5 illustrates conceptual diagrams of example audial attributes of tracks.

FIG. 6 shows a graphical representation of example audial attribute scores for a first example set of prior tracks in a listening session.

FIG. 7 shows a graphical representation of segmenting the audial attribute scores for the first example set of prior tracks of FIG. 6 into attribute score groups.

FIG. 8 shows a graphical representation of segmenting the audial attribute scores for the first example set of prior tracks of FIG. 6 into other attribute score groups.

FIG. 9 shows a graphical representation of example audial attribute scores for a second example set of prior tracks in a listening session.

FIG. 10 shows a graphical representation of segmenting the audial attribute scores for the second example set of prior tracks of FIG. 9 into attribute score groups.

FIG. 11 shows graphical representations of example audial attribute scores for multiple audial attributes for a set of prior tracks in different example listening sessions.

FIG. 12 shows a chart of attribute score groups and context indicators associated with an example set of prior tracks.

FIG. 13 shows charts for an example re-ranking of candidate tracks based on the attribute score groups of FIG. 12.

FIG. 14 shows a chart of attribute score groups and context indicators associated with an example set of prior tracks.

FIG. 15 shows charts for an example re-ranking of candidate tracks based on the attribute score groups of FIG. 14.

FIG. 16 shows a chart of attribute score groups for multiple audial attributes and context indicators associated with an example set of prior tracks.

FIG. 17 shows charts for an example re-ranking of candidate tracks based on the attribute score groups of FIG. 16.

FIG. 18 illustrates an example method for updating audial attribute score groups as a listening session progresses.

### DETAILED DESCRIPTION

Various embodiments will be described in detail with reference to the drawings, wherein like reference numerals represent like components throughout the several views. Reference to various embodiments does not limit the scope of the claims attached hereto. Additionally, any examples set forth in this specification are not intended to be limiting and merely set forth some of the many possible embodiments for the appended claims.

Studies have shown that, during a listening session for a user (or listener), a user typically prefers subsequent tracks to have similar characteristics to the prior tracks listened to in the listening session. Stated another way, a user is more likely to dislike a track if the track has different characteristics from tracks that were previously played in that session. As a result, a media service may consider, as at least one factor, similarities between candidate tracks (track available to play in the listening session) and prior tracks in the listening session.

An audial attribute may be used to determine similarities between tracks. An audial attribute may include subjective attributes or acoustic attributes, such as rhythm, harmony, tempo, danceability, beat strength, energy, etc. A track may be scored for one or more attributes (e.g., out of 100% or from 0-1). For example, a song may be 78% danceable (i.e., a danceability score of 0.78), have 56% energy (i.e., an energy score of 0.56), etc. The attribute score for an audial attribute may differ between tracks, even within the same genre. The technology described herein evaluates similarities in tracks based on attribute scores of tracks. As further discussed above, a change in attribute score from track-to-track in a listening session (i.e., a consecutive session of songs listened to by a user) may negatively impact a listener's happiness or enjoyment of the session.

Mere similarities of attribute scores between consecutive tracks may not be enough to maintain user happiness in a listening session. For example, a user may prefer certain attribute scores over others for an audial attribute (e.g., a preference for 85% energy rather than 60% energy). Accordingly, the present technology involves determining an attribute score or range of attribute scores (an “attribute score group”) that is preferred (a “preferred attribute score group”) for one or more audial attributes for a user in a specific listening session. The preferred attribute score group may be used to re-rank or re-sequence candidate tracks (e.g., a track to potentially be selected for playback, as may be from a list or a next track that has been selected).

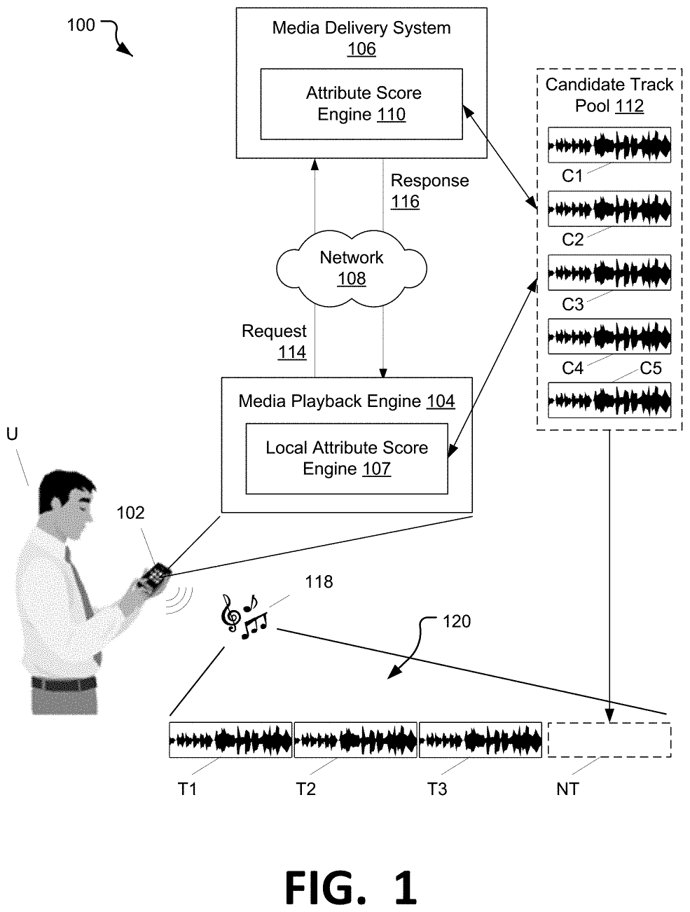

FIG. 1 illustrates an example system 100 for sequencing tracks based on audial attribute score groups of prior tracks in a listening session 120. In this example, the system 100 includes a media playback device 102 with a media playback engine 104 and a media delivery system 106, which may communicate across a network 108. The media playback device 102 may be operated by a user U. In this example, the media playback engine 104 includes a local attribute score engine 107, and the media delivery system 106 includes an attribute score engine 110. Also illustrated in FIG. 1 is a candidate track pool 112 (including candidate tracks C1-C5), request 114, response 116, media output 118, and a listening session 120. The example media output 118 includes a set of prior tracks T1, T2, T3 and a set of next tracks NT.

A media content item (e.g., a “track”), as further described herein, is an item of media content, including audio, video, or other types of media content, which are stored in any format suitable for storing media content. Non-limiting examples of media content items include sounds, songs, albums, music videos, movies, television episodes, podcasts, other types of audio or video content, and portions or combinations thereof.

The media playback device 102 is a device capable of playing media content. In this example, the media playback device 102 is operated by a user U to access the media playback engine 104 and features thereof, including the local attribute score engine 107.

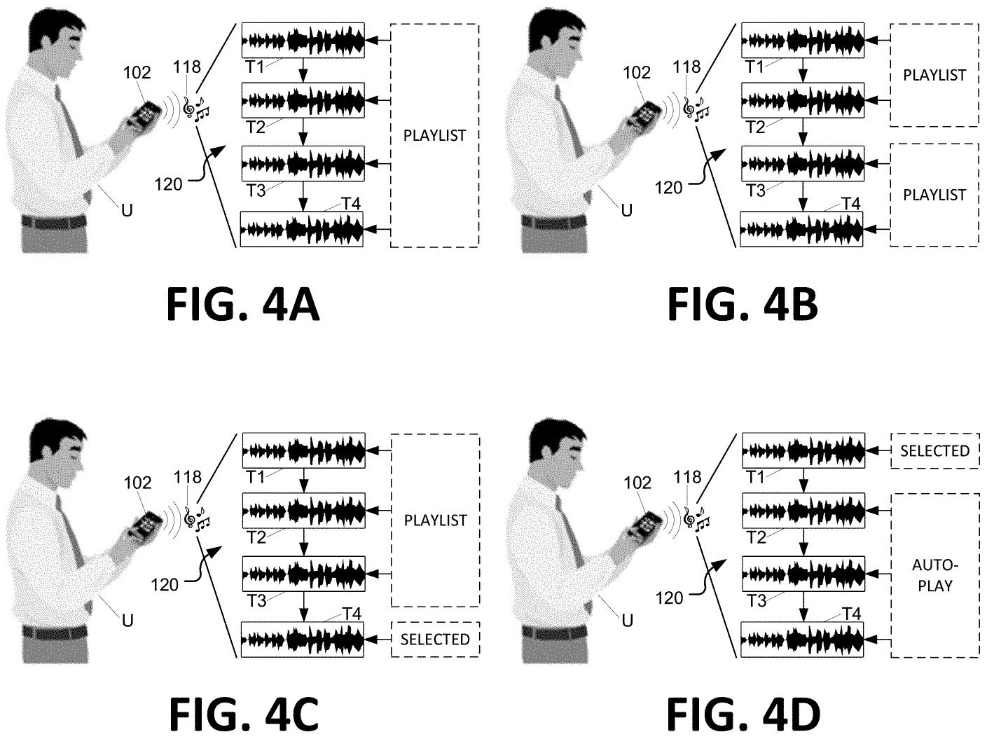

As one example, the media playback engine 104 plays audio tracks and the local attribute score engine 107 selects a next track NT (or queued set of tracks NT) for future play by the media playback device 102. The media playback device 102 may also operate to enable playback of one or more media content items (e.g., playback of a first track T1, second track T2, third track T3) to produce media output 118 for a listening session 120. A listening session 120 includes consecutive media content items played (e.g., first track T1, second track T2, third track T3) or to be played (e.g., next track NT) during a period when the user U is actively using the media playback engine 104. The listening session 120 thus includes a sequence of media content items in order of playback by the media playback device 102. Additional aspects of a listening session are further described herein with respect to at least FIGS. 4A-4D.

The media delivery system 106 can be associated with a media service that provides a plurality of applications having various features that can be accessed via media playback devices, such as the media playback device 102. In some examples, a media playback engine 104 that includes a local attribute score engine 107 runs on the media playback device 102 and an attribute score engine 110 runs on the media delivery system 106. The media delivery system 106 operates to provide the media content items to the media playback device 102 prior to playback by the media playback device 102. In some embodiments, the media delivery system 106 is connectable to a plurality of media playback devices 102 and provides the media content items to the media playback devices 102 independently or simultaneously.

A candidate track pool 112 includes candidate tracks (e.g., candidate tracks C1-C5) for selection as one or more of the next tracks NT for playback in the listening session 120. The candidate track pool is available for selection of one or more candidate tracks by the attribute score engine 110 of the media delivery system 106 and/or the local attribute score engine 107 of the media playback engine 104. In some examples, the candidate track pool 112 is provided by the media delivery system 106 to the media playback device 102 across the network 108 for storage at the media playback engine 104. In another example, candidate tracks of the candidate track pool 112 are streamed across the network 108 from the media delivery system 106 to the media playback engine 104. One or more tracks of the candidate track pool 112 may be transmitted across the network 108 at a time. Transmission of candidate tracks and/or the candidate track pool 112 may be one-time or periodic.

As shown in FIG. 1, a media playback device 102 may produce media output 118 for a listening session 120 for a user U. The produced media output 118 includes a set of prior tracks (e.g., prior tracks T1, T2, T3) and a set of next tracks NT for the listening session 120. Although three prior tracks are shown in this example, the set of prior tracks may include any number of tracks previously played in the present listening session 120, which may include all prior tracks for that listening session 120 or a subset of the prior tracks played in the listening session 120 (e.g., a moving window, the prior n tracks, tracks up until the last skipped track, etc.).

To select one or more next tracks NT for the listening session, the media playback engine 104 may submit a request 114 to the media delivery system 106. The request 114 may include an evaluation of attribute score groups based on the prior tracks at a current time in the listening session 120. For example, the request 114 may query the media delivery system 106 for a quantity of attribute score groups and their associated attribute score value or value range for one or more audial attributes of the prior tracks. The request 114 may also query the media delivery system 106 for a preferred attribute score group for the audial attribute (or preferred groups for each of multiple audial attributes). Multiple audial attributes include two or more audial attributes.

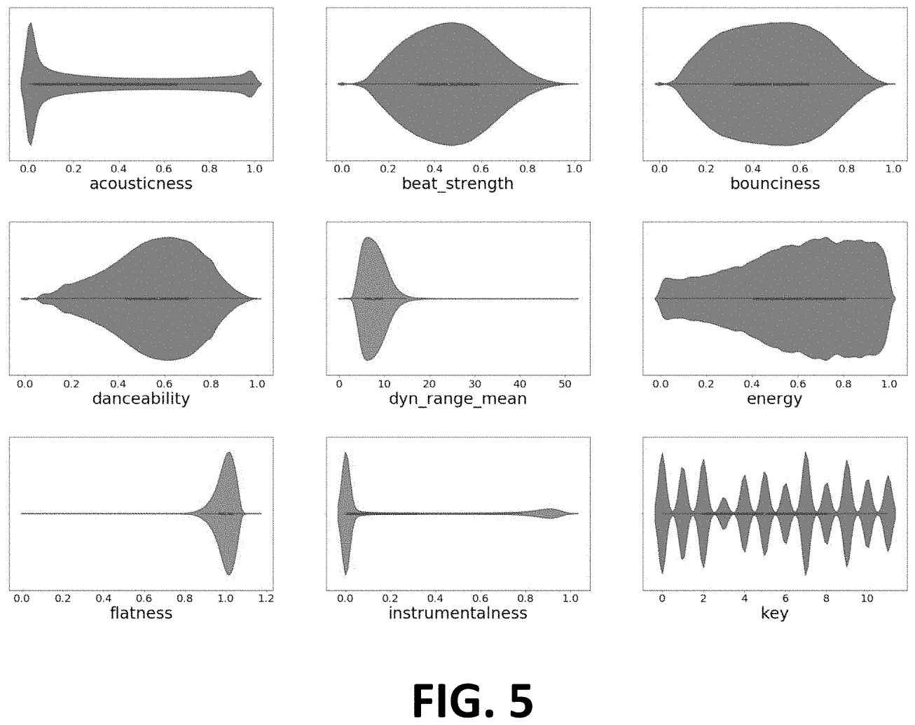

Each of the prior tracks is associated with an attribute score for at least one audial attribute for the track (e.g., 0.7 score for danceability). If multiple audial attributes are considered, each track is associated with multiple audial attribute scores (e.g., one score for each audial attribute). Audial attributes and scores of audial attributes are further described herein at least with respect to FIG. 5. The attribute score(s) for each prior track of the listening session 120 can be known by the local attribute score engine 107 on the media playback device 102. For example, the attribute score(s) can be extracted or identified from metadata associated with each prior track, determined using a lookup table, and/or determined by the local attribute score engine 107. Alternatively, the attribute score(s) for the prior tracks may not be known by the media playback device 102 and may instead be known or identifiable by the media delivery system 106.

In an example where the attribute score(s) for the prior tracks in the listening session 120 are known or otherwise identified by the local attribute score engine 107, the request 114 can include a set of attribute scores for the prior tracks. Alternatively, where the attribute score(s) are not known by the media playback engine 104, identification information for the prior tracks can be provided in the request 114 to allow the media delivery system 106 to lookup the prior tracks or otherwise determine the set of attribute scores for the prior tracks in the listening session 120 (e.g., using the attribute score engine 110).

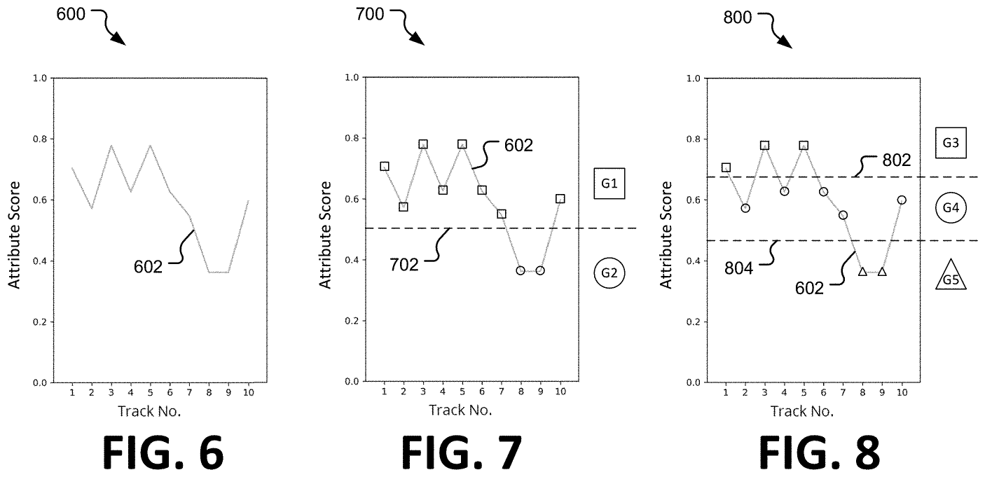

Based on the set of attribute scores for the prior tracks, the attribute score engine 110 segments the attribute scores into one or more attribute score groups. To segment the set of attribute scores, the attribute score engine 110 can utilize a segmentation model. In an example, the segmentation model is unsupervised model that uses an unsupervised approach. An example of an unsupervised model is a changepoint detection model, such as a Hidden Markov Model (HMM). Segmenting attribute scores into attribute score groups is further described herein at least with respect to FIGS. 6-10.

A benefit of such an unsupervised model is that it does not require any training data. In other words, it does not require that the process of performing segmentation be previously determined (e.g., a previous determination of how many segments there should be) and then that previous determination used to train the model. Instead, the model can be configured to make its own determination without such training. One advantage of this is that the model can be suitable for use with unseen variations in the data, such as unseen variations in audio properties across sessions.

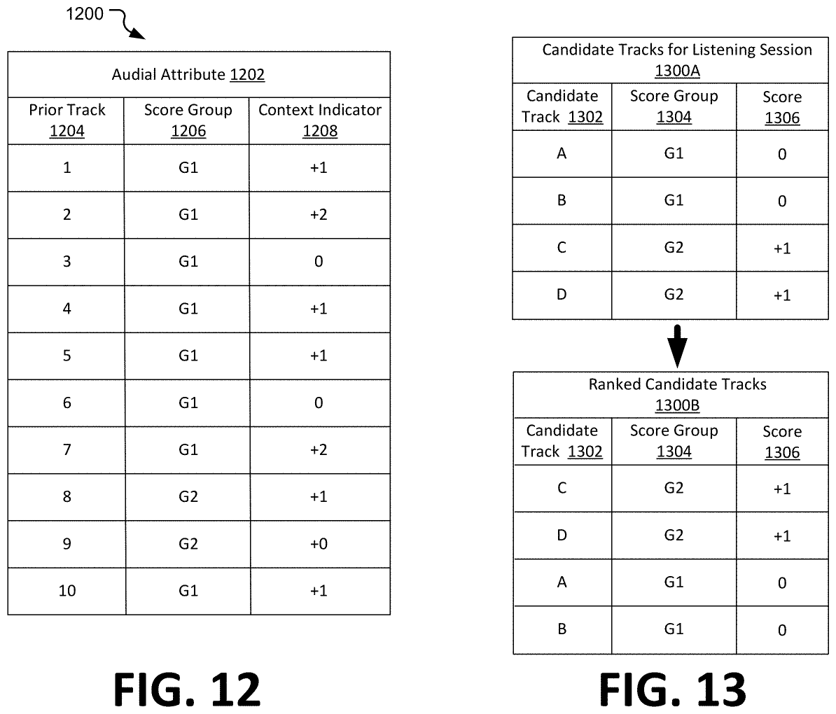

The request 114 from the media playback engine 104 can also include context indicators associated with one or more of the prior tracks in the listening session 120. Context indicators include a user's U positive, negative, or neutral feedback for one or more of the prior tracks during the current listening session 120. A context indicator can be represented a value associated with an action the user U provided to the media playback device 102 for a prior track in that listening session 120 (e.g., skip, like, dislike, un-like, etc.). The local attribute score engine 107 can associate a representative context value with each of the prior tracks to provide to the media delivery system 106 in the request 114. Examples of context indicators represented by values are further described herein at least with respect to FIGS. 12, 14, and 16.

The request 114 can also query the media delivery system 106 for a preferred attribute score group of the set of attribute score groups (segmented from a set of attribute scores for the prior tracks). The attribute score engine 110 at the media delivery system 106 can evaluate a preference and/or rank of each of the segmented attribute score groups based on the context indicators provided in the request 114 from the media playback engine 104. If context indicators are not otherwise provided to the media delivery system 106, the attribute score engine 110 can otherwise select a preferred group from the set of attribute score groups (e.g., at random, based on data from other users, based on data from the current user, etc.). In an example, a preferred group may not be selected.

After the media delivery system 106 segments the attribute scores of the prior tracks for the listening session into a set of attribute score groups and optionally determines a preferred group of the set of attribute score groups, one or more candidate tracks (e.g., candidate tracks C1-C5) from the candidate track pool 112 for the listening session 120 may be ordered, sequenced, re-ordered, or re-sequenced for future selection or playback as one or more next tracks NT.

Ordering or sequencing of the candidate tracks in the candidate track pool 112 can be performed by the attribute score engine (e.g., by a ranking engine) and/or the local attribute score engine 107, depending on where the candidate track pool 112 is stored. For example, a candidate track pool 112 stored at the media delivery system 106 (e.g., for one or more candidate tracks to be sent to the media playback engine 104) is sequenced by the media delivery system 106. Alternatively, if some or all candidate tracks and/or the candidate track pool 112 are stored at the media playback engine 104, the local attribute score engine 107 sequences the candidate tracks. Sequencing of the candidate tracks can result in the candidate tracks being grouped and sorted based on which of the attribute score group each of the candidate tracks can be categorized. The sorting order of the attribute score groups is based on the preferred group (if a preferred group is determined). Ordering or sequencing candidate tracks is further described herein at least with respect to FIGS. 13, 15, and 17. The sequenced candidate tracks are then be used to select the next track NT (e.g., in the newly sequenced order) for playback by the media playback device 102. After playback, the next track NT is considered as a prior track in the listening session 120 and another next track NT is selected from the sequenced candidate tracks. The candidate tracks may be re-sequenced from time to time as the listening session 120 progresses.

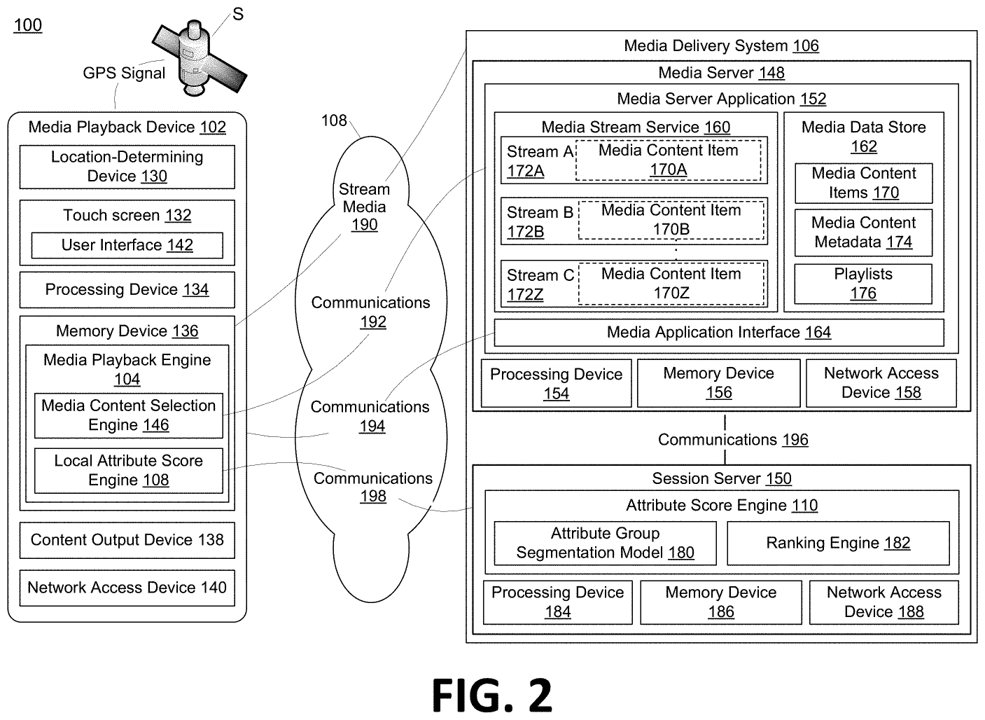

FIG. 2 illustrates another example of the system 100 for sequencing tracks based on audial attribute score groups of prior tracks in a listening session 120. The system 100 includes the media playback device 102, the media delivery system 106, and the network 108. The media playback device 102 includes memory device 136 with media playback engine 104, location-determining device 130, touch screen 132, processing device 134, content output device 138, and network access device 140. The media delivery system 106 includes media server 148 and session server 150. The media server includes a media server application 152, processing device 154, memory device 156, and network access device 158. The session server 150 includes the attribute score engine 110, a processing device 184, a memory device 186, and network access device 188.

As described herein, the media playback device 102 operates to execute the media playback engine 104, including at least local attribute score engine 107 for evaluating candidate tracks based on their audial attribute scores (e.g., as compared with attribute score groups and/or a preferred group provided by the media delivery system 106). In some examples, the media playback engine 104 can be one of a plurality of engines provided by a media service associated with the media delivery system 106. In an example, the media playback engine 104 runs an application at the media playback device 102. In an instance, a thin version of an application (e.g., a web application accessed via a web browser operating on the media playback device 102) or a thick version of an application (e.g., a locally installed application on the media playback device 102) can be executed.

As one non-limiting and non-exhaustive example, the media playback engine 104 is an audio engine and the local attribute score engine 107 allows evaluation of, or selection of, one or more media content items based on an attribute score of the media content items, an attribute score group of the media content items, and/or a preferred attribute score group (e.g., as may be determined at the media delivery system 106 using attribute score engine 110). In some examples, media content items for future play (e.g., candidate tracks C1, C2, C3, etc.) are provided (e.g., streamed, transmitted, etc.) by a system external to the media playback device such as the media delivery system 106, another system, or a peer device. Alternatively, in some embodiments, some or all of media content items for future play are stored locally at the media playback device 102. Further, in at least some examples, the media playback device 102 evaluates and/or re-sequences media content items for future play based on attribute scores, attribute score groups, and/or a preferred score group.

In some embodiments, the media playback device 102 is a computing device, handheld entertainment device, smartphone, tablet, watch, wearable device, or any other type of device capable of executing applications such as local attribute score engine 107. In yet other embodiments, the media playback device 102 is a laptop computer, desktop computer, television, gaming console, set-top box, network appliance, Blu-ray™ or DVD player, media player, stereo, or radio.

In at least some examples, the media playback device 102 includes a location-determining device 130, a touch screen 132, a processing device 134, a memory device 136, a storage device 137, a content output device 138, and a network access device 140. Other embodiments may include additional, different, or fewer components. For example, some embodiments include a recording device such as a microphone or camera that operates to record audio or video content. As another example, some embodiments do not include one or more of the location-determining device 130 and the touch screen 132.

The location-determining device 130 is a device that determines the location of the media playback device 102. In some embodiments, the location-determining device 130 uses one or more of the following technologies: Global Positioning System (GPS) technology which can receive GPS signals from satellites, cellular triangulation technology, network-based location identification technology, Wi-Fi® positioning systems technology, and combinations thereof.

The touch screen 132 operates to receive an input from a selector (e.g., a finger, stylus etc.) controlled by the user U. In some embodiments, the touch screen 132 operates as both a display device and a user input device. In some embodiments, the touch screen 132 detects inputs based on one or both of touches and near-touches. In some embodiments, the touch screen 132 displays a user interface 142 for interacting with the media playback device 102. As noted above, some embodiments do not include a touch screen 132. Some embodiments include a display device and one or more separate user interface devices. Further, some embodiments do not include a display device.

In some embodiments, the processing device 134 comprises one or more central processing units (CPU). In other embodiments, the processing device 134 additionally or alternatively includes one or more digital signal processors, field-programmable gate arrays, or other electronic circuits.

The memory device 136 operates to store data and instructions. In some examples, the memory device 136 stores instructions for the media playback engine 104 having the local attribute score engine 107. Additionally, a user profile associated with media playback engine 104 and/or the media service can be stored that includes at least a user identifier. The memory device 136 can also temporarily store scores and/or score ranges for attribute score groups and/or a preferred attribute score group provided by the media delivery system 106 while the media playback engine 104 is running (e.g., executing on) the media playback device 102. In an example, the local attribute score engine 107 groups media content into at least one of the attribute score groups provided by the media delivery system 106. The grouped media content can then be evaluated, scored, or ranked based on a preferred attribute score group provided by the media delivery system 106. The media content (e.g., as evaluated, scored, or ranked) can be sequenced by either the local attribute score engine 107 and/or the media content selection engine 146 for ordering playback of the media content by the media playback engine 104. As updated attribute score groups and/or updated preferred attribute score group(s) are provided from the media delivery system 106 to the media playback engine 104, the updated information can replace any prior stored attribute score groups and/or preferred attribute score groups at the memory device 136 of the media playback device 102.

Computer readable media includes any available media that can be accessed by the media playback device 102. By way of example, the term computer readable media as used herein includes computer readable storage media and computer readable communication media.

The memory device 136 is a computer readable storage media example (e.g., memory storage). Computer readable storage media includes volatile and nonvolatile, removable and non-removable media implemented in any device configured to store information such as computer readable instructions, data structures, program modules, or other data. Computer readable storage media includes, but is not limited to, random access memory, read only memory, electrically erasable programmable read only memory, flash memory and other memory technology, compact disc read only memory, Blu-ray Disc®, digital versatile discs or other optical storage, magnetic cassettes, magnetic tape, magnetic disk storage or other magnetic storage devices, or any other medium that can be used to store the desired information and that can be accessed by the media playback device 102. In some embodiments, computer readable storage media is non-transitory computer readable storage media.

Computer readable communication media typically embodies computer readable instructions, data structures, program modules or other data in a modulated data signal, such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The content output device 138 operates to output media content. In some embodiments, the content output device 138 generates media output 115 (FIG. 1) for the user U. Examples of the content output device 138 include a speaker, an audio output jack, a BLUETOOTH® transmitter, a display panel, and a video output jack. Other embodiments are possible as well. For example, the content output device 138 may transmit a signal through the audio output jack or BLUETOOTH® transmitter that can be used to reproduce an audio signal by a connected or paired device such as headphones or a speaker.

The network access device 140 operates to communicate with other computing devices over one or more networks, such as the network 108. Examples of the network access device include wired network interfaces and wireless network interfaces. Wireless network interfaces include infrared, BLUETOOTH® wireless technology, 802.11a/b/g/n/ac, and cellular or other radio frequency interfaces in at least some possible embodiments.

The media delivery system 106 includes one or more computing devices and operates to provide media content items to the media playback device 102 and, in some embodiments, other media playback devices as well. In some embodiments, the media delivery system 106 operates to transmit the stream media 190 to media playback devices such as the media playback device 102.

In some embodiments, the media delivery system 106 includes a media server 148 and a session server 150. In this example, the media server 148 includes a media server application 152, a processing device 154, a memory device 156, and a network access device 158. The processing device 154, memory device 156, and network access device 158 may be similar to the processing device 134, memory device 136, and network access device 140 respectively, which have each been previously described.

In some embodiments, the media server application 152 operates to stream music or other audio, video, or other forms of media content. The media server application 152 includes a media stream service 160, a media data store 162, and a media application interface 164.

The media stream service 160 operates to buffer media content such as media content items 170 (including 170A, 170B, and 170Z) for streaming to one or more streams 172A, 172B, and 172Z.

The media application interface 164 can receive requests or other communication from media playback devices or other systems, to retrieve media content items from the media delivery system 106. For example, in FIG. 2, the media application interface 164 receives communications 194 from the media playback device 102. In some aspects, the media content items requested to be retrieved include the one or more media content items selected by the user U utilizing the media playback engine 104, where those selected media content items are to be sequenced based on their attribute scores as compared with attribute score groups provided by the media delivery system 106.

In some embodiments, the media data store 162 stores media content items 170, media content metadata 174, and playlists 176. The media data store 162 may comprise one or more databases and file systems. Other embodiments are possible as well. As noted above, the media content items 170 can be audio, video, or any other type of media content, which may be stored in any format for storing media content.

The media content metadata 174 operates to provide various pieces of information associated with the media content items 170. In some embodiments, the media content metadata 174 includes one or more of title, artist name, album name, length, genre, mood, era, etc. In addition, the media content metadata 174 includes acoustic metadata which may be derived from analysis of the track. Acoustic metadata can include temporal information such as tempo, rhythm, beats, downbeats, tatums, patterns, sections, or other structures. Acoustic metadata can also include spectral information such as melody, pitch, harmony, timbre, chroma, loudness, vocalness, or other possible features. Acoustic metadata can be evaluated as a score for one or more audial attributes, such as acousticness, beat strength, bounciness, danceability, dynamic range mean, energy, flatness, instrumentalness, key, etc. The media content metadata 174 can include attribute scores for the media content items 170 for one or more audial attributes (e.g., predetermined attribute scores).

The playlists 176 operate to identify one or more of the media content items 170. In some embodiments, the playlists 176 identify a group of the media content items 170 in a particular order. In other embodiments, the playlists 176 merely identify a group of the media content items 170 without specifying a particular order. Some, but not necessarily all, of the media content items 170 included in a particular one of the playlists 176 are associated with a common characteristic such as a common genre, mood, or era. Media content items 170 of playlists 176 may be re-ordered or re-sequenced based on the techniques described herein.

In the example shown in FIG. 2, the session server 150 includes an attribute score engine 110, an attribute score group segmentation model 180, a ranking engine 182, a processing device 184, a memory device 186, and a network access device 188. The processing device 184, memory device 186, and network access device 188, may be similar to the processing device 134, memory device 136, and network access device 140, respectively.

As shown in the example system 100 of FIG. 2, the attribute score engine 110 includes an attribute score group segmentation model 180 and a ranking engine 182. The attribute score engine 110 receives information associated with, or relating to, prior tracks in a listening session. Information about the prior tracks in the listening session may include a set of audial attribute scores for one or more audial attributes of each of the prior tracks and context information (which may be in the form of values) associated with user U feedback provided in the current listening session regarding each prior track. The attribute score group segmentation model 180 segments the set of audial attribute scores into a set of score groups for each audial attribute. The attribute score group segmentation model 180 can also determine a preferred score group for each set of score groups. The preferred score group can be based on the context information, if received.

The ranking engine 182 assigns each candidate track (e.g., of a candidate track pool 112) to one of the score groups of the set of score groups based on audial attribute scores of the candidate tracks. For example, if two score groups are determined for a set of score groups for an audial attribute—Group 1 is a score above 0.65 for the audial attribute and Group 2 is a score at or below 0.65 for the audial attribute—a first candidate track C1 with a score of 0.7 is assigned to Group 1 and a second candidate track C2 with a score of 0.6 is assigned to Group 2. Based on the assignment of the candidate tracks into the score groups, the ranking engine 182 ranks (e.g., orders or sequences) the candidate tracks. In an example where a preferred group is determined, the candidate tracks are ranked based on the preferred group (e.g., continuing the above example, if Group 1 is preferred, then the first candidate track C1 is ranked above the second candidate track C2). The ranked candidate tracks are then used to select, in order, a set of next tracks NT for playback in the listening session 120 at the media playback device 102.

Referring still to FIG. 2, the network 108 is an electronic communication network that facilitates communication between the media playback device 102 and the media delivery system 106. An electronic communication network includes a set of computing devices and links between the computing devices. The computing devices in the network use the links to enable communication among the computing devices in the network. The network 108 can include routers, switches, mobile access points, bridges, hubs, intrusion detection devices, storage devices, standalone server devices, blade server devices, sensors, desktop computers, firewall devices, laptop computers, handheld computers, mobile telephones, and other types of computing devices.

In various embodiments, the network 108 includes various types of links. For example, the network 108 can include wired and/or wireless links, including BLUETOOTH®, ultra-wideband (UWB), 802.11, ZigBee®, cellular, and other types of wireless links. Furthermore, in various embodiments, the network 108 is implemented at various scales. For example, the network 108 can be implemented as one or more local area networks (LANs), metropolitan area networks, subnets, wide area networks (such as the Internet), or can be implemented at another scale. Further, in some embodiments, the network 108 includes multiple networks, which may be of the same type or of multiple different types.

Although FIG. 2 illustrates only a single media playback device 102 communicable with a single media delivery system 106, in accordance with some embodiments, the media delivery system 106 can support the simultaneous use of multiple media playback devices, and the media playback device 102 can simultaneously interact with multiple media delivery systems. Additionally, although FIG. 2 illustrates a streaming media-based system, other embodiments are possible as well.

While FIGS. 1 and 2 describe example audio-based applications executing on media playback devices that are interacting with a media delivery system associated with a media service, the types of applications having features that use machine learning models and associated systems in which access-controlled, on-device machine learning models can be implemented are not so limited.

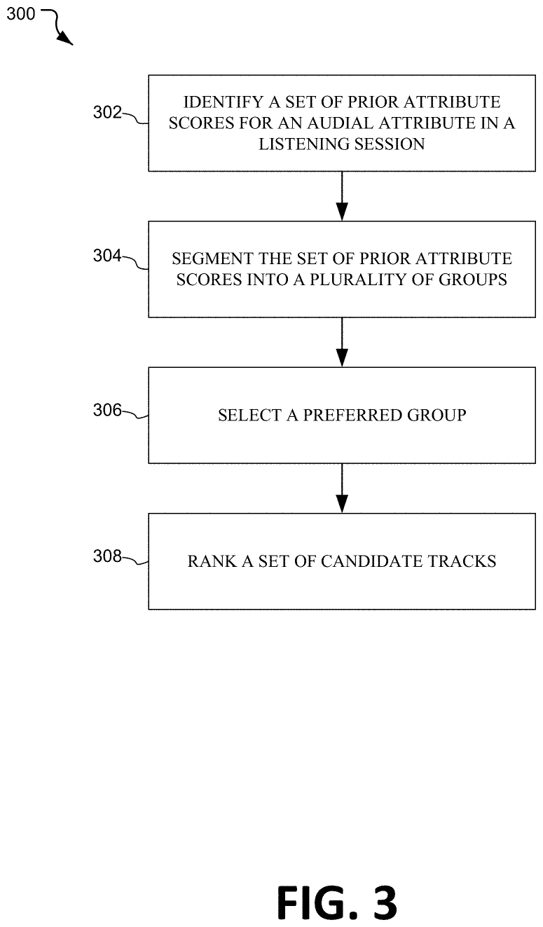

FIG. 3 illustrates an example method 300 for sequencing tracks based on audial attribute score groups of prior tracks in a listening session. In this example, the method 300 is performed by the system 100 described in FIG. 1 and FIG. 2. The method includes operations 302, operation 304, operation 306, and operation 308.

At operation 302, a set of prior attribute scores for an audial attribute in a listening session are identified. A listening session is further described in FIGS. 4A-4D. An audial attribute and attribute scores for an audial attribute are described in FIG. 5. Each track in a listening session is associated with an attribute score for each audial attribute considered by the present technology, which may be one or more audial attributes. Thus, for each audial attribute, there is a set of attribute scores associated with a set of prior tracks already provided for playback in the listening session. For example, if there are three prior tracks and a first track has a score of 0.9 bounciness, a second track has a score of 0.87 bounciness, and a third track has a score of 0.88 bounciness, then the set of prior attribute scores for the set of prior tracks is 0.9, 0.87, and 0.88.

In an example where multiple audial attributes are being identified, the set of attribute scores includes multiple subsets of attribute scores (e.g., one subset for each audial attribute). Continuing the prior example of three prior tracks, if the first track has a score of 0.6 danceability, the second track has a score of 0.68 danceability, and the third track has a score of 0.61 danceability, then a first subset of the set of prior attribute scores includes 0.9, 0.87, and 0.88 (e.g., associated with bounciness) and a second subset of the set of prior attribute scores includes 0.6, 0.68, and 0.61 (e.g., associated with danceability).

The attribute score (or attribute scores for multiple audial attributes) for each prior track can be identified by a media playback device (e.g., media playback device 102) or by a media delivery system (e.g., media delivery system 106). The attribute score can be determined based on a comparison with a standard or template for an audial attribute. Alternatively, the attribute score can be previously determined and associated with a track and can be extracted or identified from metadata of the track or from a lookup table.

At operation 304, the set of prior attribute scores are segmented into a plurality of groups. In an example, the set of prior attribute scores are segmented by the media delivery system. The quantity of groups (e.g., two groups, three groups, four groups, etc.) is based on a segmenting model and/or the values of the set of prior attribute scores. Segmenting of a set of prior attribute scores is further described in FIGS. 6-11.

At operation 306, a preferred group is selected. In addition to an attribute score for an audial attribute, each prior track in the listening session can also be associated with a context indicator for that listening session. In an example, the context indicator is based on feedback provided by a user of the media playback device regarding a prior track in the current listening session. If context indicators are not otherwise associated with the prior tracks a preferred group can be otherwise selected (e.g., at random, based on data from other users, based on data from the current user, etc.). In an example where there are three or more groups, preferences or ratings can be selected to assign subsequent preference after the top preferred group. Examples of selecting a preferred group based on context information is further described in FIGS. 12, 14, and 16.

At operation 308, a set of candidate tracks is ranked. The candidate tracks are grouped into one of the plurality of groups segmented from the set of prior attribute scores described in operation 304. In one example, the candidate tracks are ranked based on the preferred group and/or subsequent group preferences, selected at operation 306, and the group assignment of each of the candidate tracks. In another example, the candidate track ranking can be based on different factors, or additional factors can also be used for ranking the candidate tracks. Examples of ranking a set of candidate tracks is further described in FIGS. 13, 15, and 17.

Examples of other factors that can be used for ranking the candidate tracks include consideration of whether to include a discovery track (e.g., a track having attributes that differ from the prior attributes or from attributes of a user taste profile), whether to include a promoted track, a relevance (e.g., how likely is the user to stream the track).

In some embodiments, the method 300 further includes selecting one or more audial attributes to use for ranking the set of candidate tracks. As shown in FIG. 5, for example, a plurality of audial attributes (e.g., acousticness, beat strength, bounciness, dancability, etc.) can be analyzed for a set of tracks. In some embodiments, one or more of the plurality of audial attributes can be selected for use in ranking, and therefore the selected one or more audial attributes (and corresponding set of audial attribute scores) are analyzed. More specifically, the set of prior attribute scores that are analyzed are associated with the one or more audial attributes that are selected. In some embodiments, the segmenting 304 and ranking 308 are then performed based on the selected one or more audial attributes.

In some embodiments, analyzing the plurality of audial attributes to select the one or more audial attributes to use for ranking the set of candidate tracks is performed by a supervised machine learning model that determines the selected one or more audial attributes. In another example, the machine learning model is a classifier machine learning model. An example of a classifier machine learning model includes a gradient boost machine learning model.

In some embodiments, analyzing the plurality of audial attributes to select the one or more audial attributes to use for ranking the set of candidate tracks includes analyzing one or more features. Examples of the one or more features include (and can be selected from): a number of tracks in each state for each audio feature, a number of state transitions for each audio feature, a number of features with states, a number of state transitions that coincide with skip/non-skip transitions, and/or other features.

FIGS. 4A-4D illustrate conceptual diagrams of example listening sessions 120 of a user U. The conceptual diagrams shown in FIGS. 4A-4D include a user U, a media playback device 102, media output 118, a listening session 120, and tracks T1-T4. Attributes of the user U, the media playback device 102, the media output 118, the listening session 120, and the tracks T1-T4 are further described herein at least with respect to FIGS. 1-2.

As referred to herein, a listening session 120 is active engagement of a user U with media output 118 played by a media playback device 102. Active engagement can be based on a time period, a pause exceeding an amount of time, time between inputs received at the media playback device 102 by the user U, logging out of an application or closing an application on the media playback device 102, location of the media playback device 102, a network to which the media playback device 102 is connected, and/or other indications that a user U is actively listening to the media output 118 of the media playback device 102. In an example, a listening session 120 begins when a user U requests that media output 118 begins playing. A listening session 120 includes candidate tracks (e.g., tracks available for future play in the current listening session) as well as prior tracks (e.g., tracks that have already been played in the current listening session).

A listening session 120 can include tracks T1-T4 from a variety of sources of candidate tracks. For example, a listening session 120 can include tracks selected from one or more of a predetermined playlist, an individual track, an autoplay, and/or other list or source of candidate tracks. A predetermined playlist is a finite list or grouping of tracks. The tracks included in a predetermined playlist can have common features or attributes, such as a shared genre, artist or set of artists, user preference, era, or any other commonality. An individual track is a single track identifiable by title, artist, and/or other identifying information. Autoplay is a track or list of tracks selected on an as-needed basis from a bank of tracks (e.g., not a finite, predetermined list of tracks, such as all available tracks on an application).

The example listening sessions 120 shown in FIGS. 4A-4D show different compositions of track selection locations. The listening session 120 of FIG. 4A shows all tracks T1-T4 in the listening session 120 selected from a single playlist. The listening session 120 of FIG. 4B shows two tracks T1-T2 selected from a first playlist and two tracks T3-T4 selected from a second playlist. The listening session 120 of FIG. 4C shows some, but not all tracks T1-T3 of a listening session 120 selected from a playlist and another track T4 selected as an individual track (e.g., a user-specified or user-identified track). The listening session 120 of FIG. 4D shows a track T1 selected as an individual track and the remaining tracks T2-T4 selected from autoplay. The listening session 120 shown in FIGS. 4A-4D are simply examples and any combination of track selection locations, in any order, is appreciated. Actions and/or preferences of the user U can define from where a next track in the listening session is selected (e.g., from a predetermined playlist, an individual track, autoplay, etc.).

FIG. 5 illustrates conceptual diagrams of example audial attributes of tracks. Example audial attributes include acousticness, dynamic range mean, key, mode, beat strength, energy, liveness, organism, time signature, bounciness, flatness, loudness, speechiness, valence, danceability, instrumentalness, mechanism, and tempo. As an example, acousticness is a confidence measure of whether the track is acoustic, energy is a perceptual measure of intensity and activity in the track, and liveness is a likelihood of the presence of an audience in the recording. As shown in FIG. 5, each audial attribute is associated with a profile (e.g., a distribution). Some audial attribute profiles have standard distributions (e.g., beat strength, bounciness, danceability, energy), while others have heavily skewed or bimodal distributions (e.g., flatness, instrumentalness, dynamic range mean).

Audial attributes can be classified into low-level, mid-level, and high-level attributes. Low-level attributes are extracted from short audio segments of length 10-100 ms, such as timbre or temporal attributes. Mid-level attributes are extracted from words, syllables, notes or a combination of low-level attributes, such as pitch, harmony, and rhythm. Lastly, high-level attributes label the entire track and provide semantic information. Commonly known features such as genre, instrument, mood fall into this category. Likewise, the techniques being used to extract audial attributes also vary across the different levels of features.

In general, low-level features are normally extracted using signal processing techniques. Firstly, audio signals are transformed using transformation methods like Discrete Cosine Transform, Fast Fourier Transform, or constant-Q transform. From the spectrum obtained, spectral features such as Mel-Frequency Cepstral Coefficients, spectral flatness measures, amplitude spectrum envelope can be extracted. Besides the adoption of features commonly associated with signal processing as described above, statistical methods are also used to capture temporal variations into audio signals. Parameters like mean, variance, kurtosis, or a combination can be used to form feature vectors. Probabilistic models such as Hidden Markov Models (HMM) have also been used to extract temporal features.

Mid-level features are normally derived from more specific algorithms, such as pitch values being extracted using frequency estimation and pitch analysis algorithms. Harmony, of which chord sequences play a major role, can be extracted by a variety of chord-detection algorithms. Rhythmic attributes such as beats per minute or tempo can be computed by the recurrence of the most repeated pattern in an audio track, or the envelope of an auto-correlation of the audio signal. However, better results in music information retrieval (MIR) tasks can often be obtained by combining low and mid-level attributes. Given the combinatorial explosion of features, feature selection also becomes paramount when selecting the ideal set of attributes for MIR tasks.

Lastly, high-level attributes, which are usually categorical features, are extracted from low and mid-level features using a variety of classification models. Supervised classification models have been used, such as k-nearest neighbors (KNN), support vector machines (SVM), Gaussian mixture models (GMM), and artificial neural networks (ANN). Identification of vocal sections can apply a two-state HMM with vocal and non-vocal states on melody information.

A track's similarity or dissimilarity to each audial attribute profile defines a score of the track for each audial attribute. The score for each audial attribute is evaluated independently. The scores are on a fixed scale (e.g., from 0-1, from 0%-100%, from 0-1000, etc.). It is possible for a track to have relatively high scores for multiple audial attributes. Likewise, a track can have relatively low scores for multiple attributes.

For each candidate track available to be played in the listening session 120, audial attribute(s), and their respective attribute score(s), can be predetermined, determined at the beginning of a listening session, or determined for a next candidate track available for playback. Within the listening session, a threshold quantity of prior tracks (e.g., a quantity of seed songs) may be provided for playback in the session, prior to implementing the techniques provided below.

After a threshold quantity of seed songs have been provided for playback in the listening session 120, audial attributes, and their respective attribute scores, are extracted or identified for each prior track for the listening session 120. Additionally, user input associated with each prior track in the session is identified (such as like, dislike, or skip, referred to as a “context indicator”). A context indicator may also include information about a change in attribute score between consecutive tracks. Context indicators are further described herein at least with respect to FIGS. 12-17.

A set of prior attribute scores may be aggregated for the attribute score of each prior track. Based on the set of prior attribute scores for the prior tracks, the set of prior attribute scores may be segmented into a plurality of attribute score groups for the listening session 120. Segmentation into attribute score groups includes (1) determining a quantity of attribute score groups that is appropriate, and also (2) determining a value or range of values for the attribute scores to assign to each of the attribute score groups. The quantity of attribute score groups, as well as the values or ranges for each attribute score group, may change as the listening session 120 progresses from track-to-track.

The quantity of attribute score groups and the value/range for each attribute score group varies from track-to-track and from session-to-session. The quantity of attribute score groups and the value/range for each attribute score group may be determined on a track-by-track basis. Segmentation of the set of prior attribute scores into attribute score groups may be determined using a changepoint detection algorithm, such as a Hidden Markov Model.

The attribute scores can be segmented into attribute score groups using a Hidden Markov Model (HMI), with k discrete score groups zₜ ∈{1, 2, . . . , k}. To model movement between score groups along the listening session 120, a transition model with a categorical distribution can be used, such that the probability of staying in the previous score group or transiting to another score group is uniform zₜ|zₜ−1˜Cat({1/k, . . . , 1/k}). The emission probabilities are defined using a normal distribution xₜ˜N(μ_{zt}, σ²_{feat}) where μ_{zt} is the mean of the trainable attribute score groups, and σ²_{feat} is the average standard deviation of the corresponding audial attribute across all listening sessions. An estimate of the number of score groups is also estimated zₜ˜N(μ_{feat}, σ²_{feat}), using the average mean and standard deviation of the corresponding audial attribute across all sessions.

To train the model, an Adam optimizer with a learning rate of 0.1 can be used to compute the Maximum a Posteriori (MAP) fit to the observed values:

μMAP=argmax μp(z1:T|x1:T) (Eqn. 1)

After the model is trained or fitted, the marginal posterior distribution p(Zₜ=zₜ|x1:T) over the score groups for each timestep are determined, using a forward-backward algorithm. A score group is then assigned to each track in the listening session 120:

z*ₜ=argmax_{zt}p(zt|x1:T) (Eqn. 2)

In an example, k can be set to 10 (or another estimate of a possible maximum number of possible score groups for a listening session 120, which depends on the length of a listening session 120), thereafter merging score groups with a similar mean. Examples of segmenting audial attribute scores into score groups is further described in at least FIGS. 7, 8, 10, and 11.

After determining the quantity of attribute score groups (e.g., using an HMM) and their respective value/range for the current listening session, a preferred attribute score group for an attribute is determined. The determination of the preferred attribute score group is based on one or more context indicators. For example, if a track classified in group 1 is skipped and a track classified in group 2 is not skipped, then group 2 may be preferable to group 1 (i.e., the skip indicates that the user didn't like that group as much.) Context indicators and preferred attribute score groups are further described herein at least with respect to FIGS. 12, 14, and 16. Remaining candidate tracks may be re-ranked or re-sequenced based on whether the candidate track is classified within the value/range associated with the preferred attribute score group. Ranking candidate tracks is further described herein at least with respect to FIGS. 13, 15, and 17.

FIG. 6 shows a graphical representation 600 of example audial attribute scores for a first example set of prior tracks 602 in a listening session. FIG. 7 shows a graphical representation 700 of segmenting the audial attribute scores for the first example set of prior tracks 602 of FIG. 6 into attribute score groups G1, G2. FIG. 8 shows a graphical representation 800 of segmenting the audial attribute scores for the first example set of prior tracks 602 of FIG. 6 into attribute score groups G3, G4, G5. The set of prior tracks 602 shown in FIGS. 6-8 includes 10 tracks previously played in the listening session (otherwise referred to herein as prior tracks). The graphical representations 600, 700, 800 of the set of prior tracks 602 show an attribute score for each track in the set of prior tracks 602 for a single audial attribute (e.g., energy, danceability, acousticness, etc.). In the example set of prior tracks 602 shown in FIGS. 6-8, the attribute scores (as represented by the y-axis) for each track in the set of prior tracks 602 range between 0.3-0.8 for the audial attribute.

FIGS. 7 and 8 show two different ways of segmenting of the attribute scores for the set of prior tracks 602 into attribute score groups (e.g., using an HMI). In the graphical representation 700 shown in FIG. 7, the set of prior tracks 602 are segmented into two attribute score groups G1, G2. The first score group G1 is represented by a square and includes each track in the set of prior tracks 602 with an attribute score above a segmenting value 702 and the second score group G2 is represented by a circle and includes each track in the set of prior tracks 602 with an attribute score less than or equal to the segmenting value 702. In the example shown in FIG. 7, the segmenting value is approximately 0.5 and thus each track with an attribute score above 0.5 is included in the first score group G1 (e.g., tracks 1, 2, 3, 4, 5, 6, 7, and 10), and each track with an attribute score less than or equal to 0.5 is included in the second score group G2 (e.g., tracks 8 and 9).

Alternatively, in the graphical representation 800 shown in FIG. 8, the set of prior tracks 602 are segmented into three attribute score groups G3, G4, G5. A different number of score groups may be determined for a set of prior tracks 602 using an HMI. For example, the training parameters provided to the HMI and/or how close a mean value of two score groups is to be combinable into one score group, can produce a different number of score groups for a single set of prior tracks 602. The first score group G3 is represented by a square and includes each track in the set of prior tracks 602 with an attribute score above a first segmenting value 802. The second score group G4 is represented by a circle and includes each track in the set of prior tracks 602 with an attribute score less than or equal to the first segmenting value 802 and greater than the second segmenting value 804. The third score group G5 is represented by a triangle and includes each track in the set of prior tracks 602 with an attribute score less than or equal to the second segmenting value 804. In the example shown in FIG. 8, the first segmenting value 802 is approximately 0.67 and the second segmenting value 804 is approximately 0.45. Thus, each track with an attribute score above 0.67 is included in the first score group G3 (e.g., tracks 1, 3, 5), each track with an attribute score less than or equal to 0.67 and greater than 0.45 is included in the second score group G4 (e.g., tracks 2, 4, 6, 7, 10), and each track with an attribute score less than or equal to 0.45 is included in the third score group G5 (e.g., tracks 8 and 9).

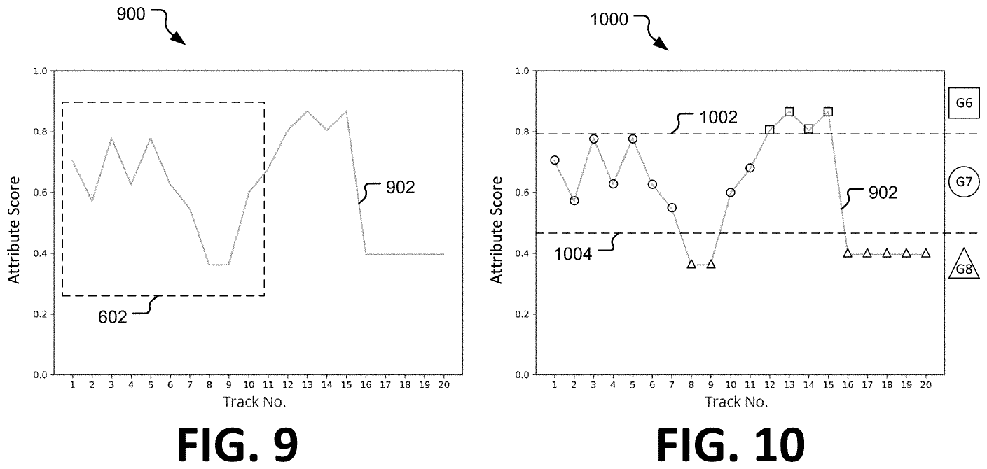

FIG. 9 shows a graphical representation 900 of example audial attribute scores for an audial attribute for a second example set of prior tracks 902 in a listening session. FIG. 10 shows a graphical representation 1000 of segmenting the audial attribute scores for the second example set of prior tracks 902 of FIG. 9 into attribute score groups G6, G7, G8. The listening session graphically represented in FIGS. 9 and 10 is an extension of the listening session graphically represented in FIGS. 6-8. To clarify, the first ten tracks of the set of prior tracks 902 shown in FIGS. 9-10 (which shows 20 prior tracks) are the set of prior tracks 602 shown in FIGS. 6-8. As shown in in the difference in score groups between FIG. 10 as compared with FIG. 7 or 8, score groups for a listening session can change as the listening session progresses (e.g., as the set of prior tracks includes more tracks).

Referring to FIG. 10, the attribute scores are segmented into three score groups G6, G7, G8. The first score group G6 is represented by a square and includes each track in the set of prior tracks 902 with an attribute score above a first segmenting value 1002. The second score group G7 is represented by a circle and includes each track in the set of prior tracks 902 with an attribute score less than or equal to the first segmenting value 1002 and greater than the second segmenting value 1004. The third score group G8 is represented by a triangle and includes each track in the set of prior tracks 902 with an attribute score less than or equal to the second segmenting value 1004. In the example shown in FIG. 10, the first segmenting value 1002 is approximately 0.79 and the second segmenting value 1004 is approximately 0.45. Thus, each track with an attribute score above 0.79 is included in the first score group G6 (e.g., tracks 12, 13, 14, 15), each track with an attribute score less than or equal to 0.79 and greater than 0.45 is included in the second score group G7 (e.g., tracks 1, 2, 4, 5, 6, 7, 10, 11), and each track with an attribute score less than or equal to 0.45 is included in the third score group G8 (e.g., tracks 8, 9, 16, 17, 18, 19, 20). The attribute score groups may be the same or different for a set of prior tracks 902 as the listening session progresses. Comparing the score groups of FIG. 8 with FIG. 10, the first segmenting value 802, 1002 are different and the second segmenting value 804, 1004 are the same. These segmenting values are shown by way of example, and quantity of score groups and segmenting values between score groups is appreciated.

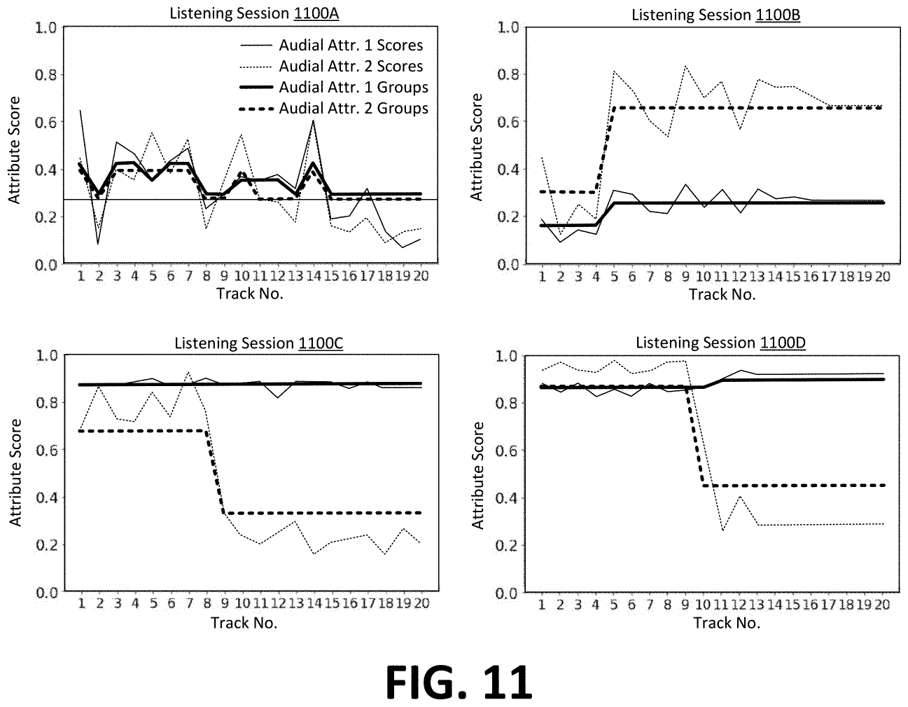

FIG. 11 shows graphical representations of example audial attribute scores for multiple audial attributes for a set of prior tracks in different example listening sessions 1100A, 1100B, 1100C, 1100D. Each of the four different listening sessions 1100A, 1100B, 1100C, 1100D shown in FIG. 11 show graphical representations of two audial attribute scores for each track in the set of prior tracks of the listening sessions 1100A, 1100B, 1100C, 1100D. Thin weight lines graphed in FIG. 11 show audial attribute scores for each track and thick weight lines graphed in FIG. 11 show attribute score groups for each track. In the listening session 1100A, the first audial attribute includes three score groups (e.g., group 1 includes tracks 1, 3, 4, 6, 7, 14; group 2 includes tracks 5, 10-121 group 3 includes tracks 2, 8, 9, 13, 15-20) and the second audial attribute includes two score groups (e.g., group 1 includes tracks 1, 3-7, 10, 14; group 2 includes tracks 2, 8, 9, 11-13, 15-20). In the listening session 1100B, the first audial attribute includes two score groups (e.g., group 1 includes tracks 1-4; group 2 includes tracks 5-20) and the second audial attribute includes two score groups (e.g., group 1 includes tracks 1-4; group 2 includes tracks 5-20). In the listening session 1100C, the first audial attribute includes one score group (e.g., tracks 1-20 are in a single score group) and the second audial attribute includes two score groups (e.g., group 1 includes tracks 1-8; group 2 includes tracks 9-20). In the listening session 1100D, the first audial attribute includes two score groups (e.g., group 1 includes tracks 1-10; group 2 includes tracks 11-20) and the second audial attribute includes two score groups (e.g., group 1 includes tracks 1-9; group 2 includes tracks 10-20).

FIG. 12 shows a chart 1200 of attribute score groups 1206 and context indicators 1208 associated with an example set of prior tracks 1204 for an audial attribute 1202. The set of prior tracks 1204 includes ten tracks, which have been segmented into two score groups 1206 represented by either G1 or G2. For example, the chart 1200 aligns with the score groups segmented from the set of prior tracks in FIG. 7. Additionally, a context indicator 1208 can be associated with each prior track 1204. A context indicator 1208 can be a numerical value associated with a user's feedback associated with a track. For example, a more positive numerical value for the context indicator can be associated with a greater preference of the track by the user. As shown in FIG. 12, the context indicators 1208 range from 0-3. In an example, a context indicator 1208 with a value of zero means that a user skipped or disliked that track, a value of one means that a user listened to the track without feedback, and a value of two means that a user liked or saved the track. Although likes and skips are discussed with respect to context indicators 1208, any user preference or feedback can influence a value of a context indicator 1208.

A user's preference for a score group 1206 in a listening session can be determined based on context indicators 1208 for each score group 1206. A preference or score for each score group 1206 can be based on any aggregation or evaluation of the context indicators 1208 for each prior track 1204. For example, context indicators 1208 for each score group 1206 of the prior tracks 1204 can be summed, averaged, a weighted average over time (e.g., context indicators for more recently played tracks are weighted more than less recently played tracks in the listening session), or other functions can be used (individually or in combination with the foregoing functions) for evaluation of the context indicators 1208. In one example the weighted average utilizes a weighting that is based at least in part on a temporal proximity of track playback to a current time. If the user's preference of the score groups 1206 is evaluated based on an average, score group 1 (G1) of the prior tracks 1204 would have a preference value of (1+2+0+1+1+0+2+1)/8=1.0 and score group 2 (G2) of the prior tracks 1204 would have a preference value of (1+0)/2=0.5. Thus, in this example, based on the context indicators 1208, the user prefers score group 1 (G1) over score group 2 (G2). The preference can then be used to rank candidate tracks for future play as a next track in the listening session.

FIG. 13 shows charts for an example re-ranking of candidate tracks based on the preference of attribute score groups of FIG. 12, including an unranked candidate track chart 1300A and a ranked candidate track chart 1300B. As described herein, the score group 1304 of each candidate track 1302 (e.g., from a playlist, autoplay, etc.) can be determined based on the segmentation of the prior tracks into a quantity of groups with associated ranges or values. In the unranked candidate track chart 1300A and ranked candidate track chart 1300B, four candidate tracks 1302 (tracks A-D) are available for selection (e.g., a candidate track pool). Because two score groups 1206 were segmented for the prior tracks 1204 in the listening session, the score groups 1304 of the candidate tracks 1302 are also associated with one of the two score groups segmented (G1, G2).

As further described above, score group 1 (G1) is preferable to score group 2 (G2) for the prior tracks 1204 in the listening session. Scores for each score group 1304 can be assigned to each candidate track 1302 based on the user preference of the score group. In the example shown in FIG. 13, the preferred score group, G1, is scored +1 and the unpreferred score group, G2, is score 0. The scores 1306 can then be used to rank the candidate tracks (e.g., as shown in the ranked candidate track chart 1300B), based on the preference score 1306. The ranked candidate tracks 1302 can then be selected from, in order, to provide next tracks for playback in the listening session.

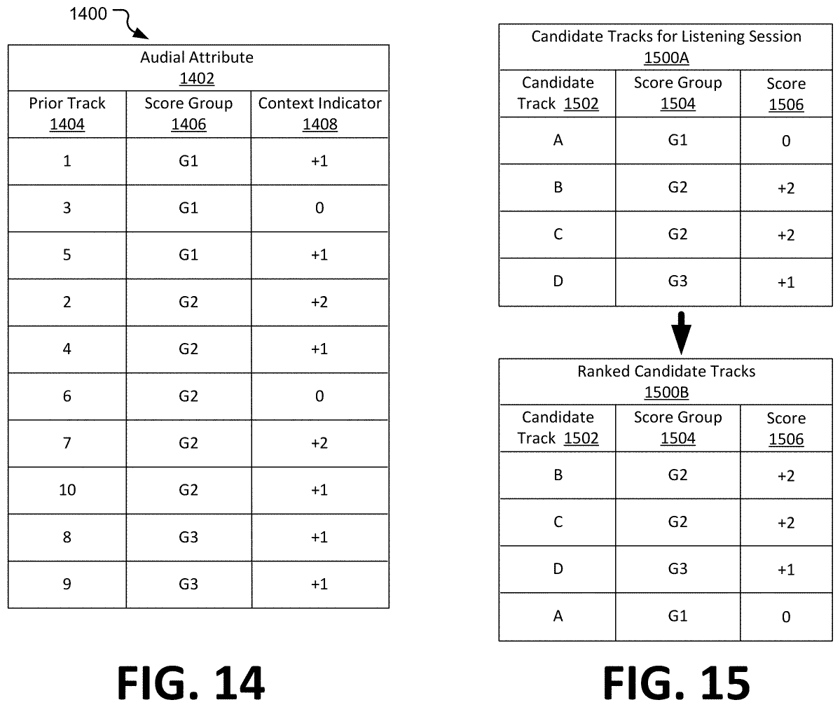

FIG. 14 shows a chart 1400 of attribute score groups 1406 and context indicators 1408 associated with an example set of prior tracks 1404 for an audial attribute 1402. The chart 1400 in FIG. 14 differs from the chart 1200 in FIG. 12 by segmenting the prior tracks into three score groups 1406 instead of two, and having different context indicators 1408 for each prior track 1404. As shown in the chart 1400 in FIG. 14, the prior tracks 1404 for the listening session are sorted based on score group 1406 for ease of discussion. For example, tracks 1, 3, and 5 are associated with score group 1, G1; tracks 2, 4, 6, 7, and 10 are associated with score group 2, G2; and tracks 8 and 9 are associated with score group 3, G3. Context indicators 1408 are associated with each prior track 1404, as further described with respect to FIG. 12. In the example shown in FIG. 14, if the user's preference of the score groups 1406 is evaluated based on an average, score group 1 (G1) of the prior tracks 1404 has a preference value of (1+0+1)/3=0.667, score group 2 (G2) of the prior tracks 1404 has a preference value of (2+1+0+2+1)/5=1.2, and score group 3 (G3) of the prior tracks 1404 has a preference value of (1+1)/2=1.0. Thus, in this example, based on the context indicators 1408, the user prefers score group 2 (G2) over score group 3 (G3) and prefers score group 3 (G3) over score group 1 (G1) (e.g., G2>G3>G1). As further described above, the preference of the score groups can then be used to rank candidate tracks for future play as a next track in the listening session.

FIG. 15 shows charts for an example ranking of candidate tracks 1502 based on the preference of attribute score groups 1406 of FIG. 14, including an unranked candidate track chart 1500A and a ranked candidate track chart 1500B. As described herein, the score group 1504 of each candidate track 1502 (e.g., from a playlist, autoplay, etc.) can be determined based on the segmentation of the prior tracks 1404 into a quantity of groups with associated ranges or values. In the unranked candidate track chart 1500A and ranked candidate track chart 1500B, four candidate tracks 1502 (tracks A-D) are available for selection (e.g., a candidate track pool). Because three score groups 1406 were segmented for the prior tracks 1404 in the listening session, the score groups 1504 of the candidate tracks 1502 are also associated with one of the three score groups segmented (G1, G2, G3).

As further described above with respect to FIG. 14, which includes the prior tracks 1404 for the listening session selecting a candidate track 1502 for playback, score group 2 (G2) is preferable to score group 3 (G3), which is preferable to score group 4 (G4) for the prior tracks 1404 in the listening session. Scores 1506 for each score group 1504 of the candidate tracks 1502 can be assigned to each candidate track 1502 based on the user preference of the score group. In the example shown in FIG. 15, the preferred score group, G2, is scored +2, the next preference of score group, G3, is scored +1, and the least preferred score group, G1, is score 0. The scores 1506 can then be used to rank the candidate tracks (e.g., as shown in the ranked candidate track chart 1500B), based on the preference score 1506, ordering candidate tracks 1502 in the second score group, G2, first, followed by candidate tracks 1502 in the third score group, G3, and then followed by candidate tracks 1502 in the first score group, G1. The ranked candidate tracks 1502 can then be selected from, in order, to provide next tracks for playback in the listening session.

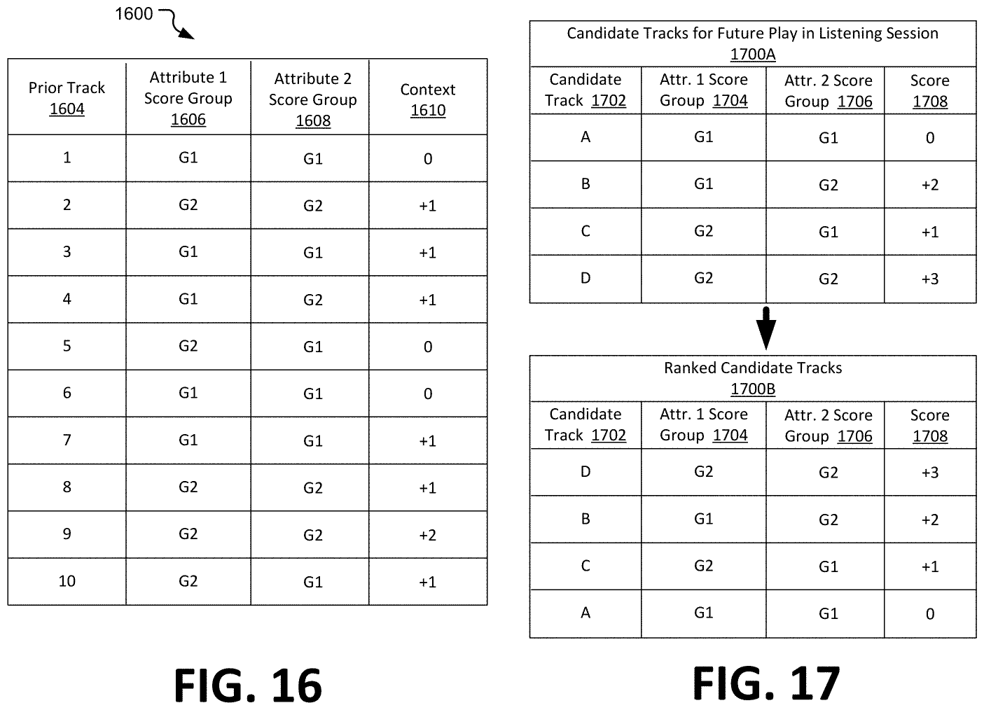

FIG. 16 shows a chart 1600 of attribute score groups 1606 of a first audial attribute, attribute score groups 1608 of a second audial attribute, and context indicators 1610 associated with an example set of prior tracks 1604. The chart 1600 in FIG. 16 differs from the chart 1200 in FIG. 12 and the chart 1400 in FIG. 14 by including attribute score groups for multiple audial attributes. As shown in the chart 1600 in FIG. 16, tracks 1, 3, 4, 6, and 7 are associated with score group 1, G1, of the first audial attribute; and tracks 2, 5, 8, 9, and 10 are associated with score group 2, G2, of the second audial attribute. Additionally, tracks 1, 3, 5, 6, 7, and 10 are associated with score group 1, G1, of the first audial attribute; and tracks 2, 4, 8, and 9 are associated with score group 2, G2, of the second audial attribute.

Context indicators 1610 are associated with each prior track 1604, as further described with respect to FIG. 12. In the example shown in FIG. 16, beginning with the first audial attribute, if the user's preference of the score groups 1606 is evaluated based on an average, score group 1 (G1) for the first audial attribute has a preference value of (0+1+1+0+1)/5=0.6 and score group 2 (G2) for the first audial attribute has a preference value of (1+0+1+2+1)/5=1.0. Turning to the second audial attribute, if the user's preference of the score groups 1608 is evaluated based on an average, score group 1 (G1) for the second audial attribute has a preference value of (0+1+0+0+1+1)/6=0.5 and score group 2 (G2) for the second audial attribute has a preference value of (1+1+1+2)/4=1.25. Thus, in this example, based on the context indicators 1610, for the first audial attribute (A1), the user prefers score group 2 (G2) over score group 1 (G1) (e.g., G2>G1 for the first audial attribute) and, for the second audial attribute (A2), the user prefers score group 2 (G2) over score group 1 (G1) (e.g., G2>G1 for the second audial attribute). Additionally, in view of the preference values of each score group, the following preference order can be established for each score group of each audial attribute: A2,G2 (1.25)>A1,G2 (1.0)>A1,G1 (0.6)>A2,G1 (0.5). As further described above, the preference of the score groups can then be used to rank candidate tracks for future play as a next track in the listening session.

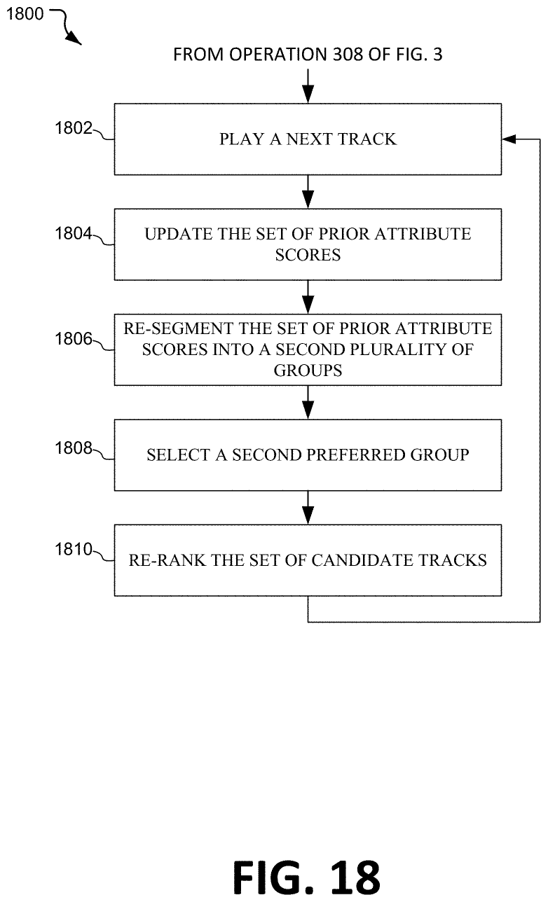

FIG. 17 shows charts for an example ranking of candidate tracks 1702 based on the preference of each of the attribute score groups 1606, 1608 of FIG. 16, including an unranked candidate track chart 1700A and a ranked candidate track chart 1700B. Similar to the difference between FIG. 16 and FIGS. 12 and 14, the difference in FIG. 17 from FIGS. 13 and 15 is that the candidate tracks 1702 are ranked and associated with a score based on score groups 1704, 1706 of multiple audial attributes. In the unranked candidate track chart 1700A and ranked candidate track chart 1700B, four candidate tracks 1702 (tracks A-D) are available for selection (e.g., a candidate track pool). Because two score groups were segmented for the first audial attribute of the prior tracks 1604 in the listening session, the score groups 1704 of the candidate tracks 1702 for the first audial attribute are also associated with one of the two score groups 1606 in FIG. 16. Likewise, because two score groups were segmented for the second audial attribute of the prior tracks 1604 in the listening session, the score groups 1706 of the candidate tracks 1702 for the second audial attribute are also associated with one of the two score groups 1608 in FIG. 16.

As further described above with respect to FIG. 16, A2,G2>A1,G2>A1,G1>A2,G1. Scores 1708 for each score group 1704, 1706 of each audial attribute of the candidate tracks 1702 can be assigned to each candidate track 1702 based on the user preference of each score group for each audial attribute. In the example shown in FIG. 17, A2,G2 adds +2 to the score 1708; A1,G2 adds +1 to the score 1708; and A1,G1 and A2,G1 (the unpreferred score groups for each audial attribute) adds +0 to the score 1708. Continuing this example, track A (A1,G1 and A2,G1) has a score 1708 of zero. Track B (A1,G1 and A2,G2) has a score 1708 of two. Track C (A1,G2 and A2,G1) has a score 1708 of one. Track D (A1,G2 and A2,G2) has a score 1708 of three. Ranking these candidate tracks 1702 in the ranked candidate track chart 1700B, track D>track B>track C>track A. The ranked candidate tracks 1702 can then be selected from, in order, to provide next tracks for playback in the listening session.

FIG. 18 illustrates an example method 1800 for updating audial attribute score groups as a listening session progresses. For example, the method 1800 includes operations directed to playback of additional tracks in a listening session beyond the operations in the method 300 described in FIG. 3. The method 1800 includes operations 1802-1810.

At operation 1802, a next track is played. The next track is selected from a candidate track pool (e.g., candidate track pool 112, candidate tracks 1302, 1502, 1702). The next track can be selected based on a ranking of the candidate track pool, which may be based on user preference, as further described in FIGS. 12-17. After the next track is provided for playback, the next track is considered to be part of the set of prior tracks for the listening session.

At operation 1804, the set of prior attribute scores is updated. After the next track is played and is considered to be part of the set of prior tracks for the listening session, the set of prior attribute scores is accordingly updated to include the attribute score (or scores, in the case of multiple audial attributes) for the played next track. For example, if tracks 1-4 were in the set of prior tracks, with attributes scores 1-4, the updated set of prior tracks includes tracks 1-4 and the next track, with attribute scores 1-4 and the attribute score associated with the next track.

At operation 1806, the set of prior attribute scores are re-segmented into a second plurality of groups. Because the set of prior attribute scores now include an attribute score associated with the played next track, the addition of the next track's attribute score can result in a different quantity of score groups (e.g., two score groups vs. three score groups) and/or a different value or range associated with each score group (e.g., score group 1 includes tracks with an attribute score above 0.65 vs. 0.79). This is further described above in the comparison of FIG. 10 with FIGS. 7 and 8.

At operation 1808, a second preferred group is selected. The second preferred group can be different from the preferred group selected at operation 306 in FIG. 3. For example, the second preferred group is different when the second plurality of groups is different from the plurality of groups described at operation 304 in FIG. 3 (e.g., different quantity of groups and/or different values/ranges for each group). Additionally, even if the second plurality of groups is the same as the plurality of groups described at operation 304 in FIG. 3, the second preferred group can be different depending on context indicators associated with the played next track. For example, if the next track is associated with a user ‘like’ or other positive context indicator, the group including the next track may become the second preferred group, even if that group was not the preferred group previously. Alternatively, the next track may not change the preferred group, such that the second preferred group is the same as the preferred group selected at operation 306 in FIG. 3. Determination of which group is preferred is further described at least with respect to FIGS. 12-17.

At operation 1810, the set of candidate tracks is re-ranked. If the second plurality of groups is different than the plurality of groups described at operation 304 in FIG. 3, then the candidate tracks are re-grouped into groups corresponding with the second plurality of groups. The candidate tracks can then be scored, based at least on the second preferred group. Based on the scores of each candidate track, the candidate tracks can be re-ranked in order of user preferences of attribute score groups. Ranking of candidate tracks is further described with respect to FIGS. 13, 15, and 17.

Operations 1802-1810 can repeat as required or desired as a listening session continues to progress. For example, operations 1802-1810 can repeat as each next track is provided for playback in the listening session, until the listening session terminates.

While the above description primarily discusses example audio-based applications, the types of applications having features that use machine learning models and apply those models on-device are not so limited. Similar methods and processes as those described herein can be applied by systems associated with these other types of applications to implement access-controlled, on-device machine learning models.

The various examples and teachings described above are provided by way of illustration only and should not be construed to limit the scope of the present disclosure. Those skilled in the art will readily recognize various modifications and changes that may be made without following the examples and applications illustrated and described herein, and without departing from the true spirit and scope of the present disclosure.

1. A method of ranking a set of candidate tracks for a listening session, the listening session including a set of prior tracks previously played and a set of candidate tracks to be selected from for future play in the listening session, the method comprising:
identifying a set of prior attribute scores associated with the set of prior tracks, wherein the set of prior attribute scores includes, for each track in the set of prior tracks, an attribute score of an audial attribute;
segmenting the set of prior attribute scores into a plurality of attribute score groups for the audial attribute for the listening session;
selecting a preferred group of the plurality of attribute score groups; and
ranking the set of candidate tracks based at least in part on the preferred group for the audial attribute.

2. The method of claim 1, wherein the set of prior tracks previously played includes prior tracks from the listening session.

3. The method of claim 1, wherein the audial attribute is a first audial attribute, the set of prior attribute scores is a first set of prior attribute scores, the plurality of attribute score groups is a first plurality of attribute score groups, and the preferred group is a first preferred group, the method further comprising:
identifying a second set of prior attribute scores associated with the set of prior tracks, wherein the second set of prior attribute scores includes, for each track in the set of prior tracks, a second attribute score of a second audial attribute;
segmenting the second set of prior attribute scores into a second plurality of attribute score groups for the second audial attribute for the listening session; and
determining a second preferred group of the second plurality of attribute score groups, wherein the ranking of the set of candidate tracks is further based at least in part on the second preferred group for the second audial attribute.

4. The method of claim 3, wherein ranking the set of candidate tracks is based on a function of a first value of the first preferred group and a second value of the second preferred group.

5. The method of claim 4, wherein the function is a weighted average, wherein the weighting is based at least in part on a temporal proximity of track playback to a current time.

6. The method of claim 1, wherein determining the preferred group is further based on weighting recent attribute scores of the set of attribute scores.

7. The method of claim 1, wherein the plurality of attribute score groups and the preferred group are determined for each track added to the set of prior tracks in the listening session.

8. The method of claim 1, the method further comprising:
identifying at least one context indicator for at least one track in the set of prior tracks, wherein the at least one context indicator is associated with one of: a positive context, a negative context, or a neutral context.

9. (canceled)

10. (canceled)

11. The method of claim 8, wherein the positive context is a like input and the negative context is one of:
a skip input;
a dislike input; or
a hide input.

12. The method of claim 8, wherein determining the preferred group is further based on weighting each track of the set of prior tracks with the positive context more than each track of the set of prior tracks associated with the negative context.

13. (canceled)

14. The method of claim 1, wherein segmenting the set of prior attribute scores into a plurality of attribute score groups is based on a changepoint detection model.

15. The method of claim 14, wherein the changepoint detection model is a Hidden Markov Model.

16. The method of claim 1, wherein the set of prior attribute scores is associated with one or more audial attributes, the method further comprising:
analyzing a plurality of audial attributes to select the one or more audial attributes to use for ranking the set of candidate tracks,
wherein segmenting the set of prior attribute scores is based on the one or more audial attributes, and
wherein ranking is based on the one or more audial attributes.

17. The method of claim 16, wherein analyzing the plurality of audial attributes to select the one or more audial attributes is performed by a supervised machine learning model that determines the selected one or more audial attributes.

18. The method of claim 16, wherein analyzing the set of prior attributes is performed by a classifier machine learning model that determines the selected one or more audial attributes.

19. The method of claim 18, wherein the classifier machine learning model includes a gradient boost machine learning model.

20. The method of claim 16, wherein analyzing the plurality of audial attributes to select the one or more audial attributes uses one or more features selected from: a number of tracks in each state for each audio feature, a number of state transitions for each audio feature, a number of features with states, and/or a number of state transitions that coincide with skip/non-skip transitions.

21. (canceled)

22. A method of ranking a set of candidate tracks for a listening session, the listening session including a set of prior tracks previously played and a set of candidate tracks to be selected from for future play in the listening session, the method comprising:
identifying a set of prior attribute scores associated with the set of prior tracks, wherein the set of prior attribute scores includes, for each track in the set of prior tracks, an attribute score of an audial attribute;
segmenting the set of prior attribute scores into a plurality of first attribute score groups for the audial attribute for the listening session;
selecting a first preferred group of the plurality of first attribute score groups;
ranking the set of candidate tracks based at least in part on the first preferred group for the audial attribute;
playing a next track, based on the ranking;
updating the set of prior attribute scores for the set of prior tracks to include an attribute score of the played next track;
re-segmenting the set of prior attribute scores, including the attribute score of the played next track, into a plurality of second attribute score groups for the audial attribute for the listening session;
selecting a second preferred group of the plurality of second attribute score groups;
re-ranking the set of candidate tracks based at least in part on the second preferred group for the audial attribute.

23. The method of claim 22, wherein the plurality of first attribute score groups and the plurality of second attribute score groups have different quantities.

24. The method of claim 22, wherein the first preferred group and the second preferred group are different.

25. The method of claim 22, the method further comprising:
identifying at least one context indicator for at least one track in the set of prior tracks.

26. The method of claim 25, wherein selecting the first preferred group and selecting the second preferred group are based on the at least one context indicator.

27. (canceled)

28. A non-transitory computer-readable medium comprising:
at least one processing device; and
one or more sequences of instructions that, when executed by the at least one processing device, cause the at least one processing device to:
identify a set of prior attribute scores associated with a set of prior tracks previously played, wherein the set of prior attribute scores includes, for each track in the set of prior tracks, an attribute score of an audial attribute;
segment the set of prior attribute scores into a plurality of attribute score groups for the audial attribute for a listening session;
select a preferred group of the plurality of attribute score groups; and
rank a set of candidate tracks to be selected from for future play in the listening session, based at least in part on the preferred group for the audial attribute.
